(19) United States
(12) Patent Application Publication
(10) Pub. No.: US 2015/0161548 A1
(43) Pub. Date: Jun. 11, 2015

(54) RETAIL SALES PLANNING CURVE MODIFICATION

(71) Applicant: Oracle International Corporation, Redwood Shores, CA (US)

(72) Inventor: Catalin POPESCU, Atlanta, GA (US)

(73) Assignee: Oracle International Corporation, Redwood Shores, CA (US)

(21) Appl. No.: 14/097,468

(22) Filed: Dec. 5, 2013

(51) Int. Cl. G06Q 10/06

(52) U.S. Cl. CPC G06Q 10/06375

(57) ABSTRACT

A system that modifies an input sales planning curve that is a time series expands the time series from an initial length time series to an expanded length time series that includes one or more missing values. The system then fills in the missing values using linear interpolation and samples the expanded time series by selecting a subset of the expanded length time series values. The system then drops the values not selected during the sampling to generate an output sales planning curve.

### FIELD

One embodiment is directed generally to a computer system, and in particular to a computer system that modifies retail sales planning curves.

### BACKGROUND INFORMATION

In order to plan future activities, many retailers rely on merchandise sales and lifecycle plans for different item categories. These plans typically consist of weekly values reflecting the selling pattern during the future lifecycle of a product. The plans are frequently viewed as time series, since they have values which are spaced at uniform time intervals/periods (e.g., weekly). For example, the time series can assess the predicted sales of an item for the next 26 weeks. The time series are typically in the form of a graph/curve of sales vs. periods.

The lengths of the plans can vary in time, which provides difficulties in adapting a plan for one product to another. Often the shape of a plan/curve is common to multiple groups of items, but the products may have different lifecycles or selling seasons. It is common for a retail planner to create one sales plan, and then uses a tool to stretch or shrink it to fit a season of different length. For example, an established sales curve may extend for 13-weeks, but a retailer may wish to use the same curve for a high fashion item that will only sell for 6-weeks. However, the known tools tend to distort the leading and trailing edges of the curve.

### SUMMARY

One embodiment is a system that modifies an input sales planning curve that is a time series. The system expands the time series from an initial length time series to an expanded length time series that includes one or more missing values. The system then fills in the missing values using linear interpolation and samples the expanded time series by selecting a subset of the expanded length time series values. The system then drops the values not selected during the sampling to generate an output sales planning curve.

### BRIEF DESCRIPTION OF THE DRAWINGS

FIG. 1 is a block diagram of a computer server/system in accordance with an embodiment of the present invention.

FIG. 2 is a flow diagram of the functionality of the retail sales planning curve modifier module of FIG. 1 when modifying a retail sales planning curve in accordance with one embodiment.

FIG. 3 illustrates an example input curve and output expanded curve in accordance with one embodiment.

FIG. 4 illustrates an example input curve and output shrunken curve for the in accordance with one embodiment.

FIGS. 5 and 6 illustrate additional examples of input and output curves in accordance with embodiments of the invention.

### DETAILED DESCRIPTION

One embodiment modifies the size of a planning curve using a Hamming window in which the new size is generated by the multiplication of the (original length−1) times the (target length−1) plus 1. The curve is then downsized, and the result is a modified planning curve with minimal boundary effects.

As described above, known tools to modify a planning curve apply a transformation that takes the source and the target lengths and fits the original curve to the new length. The transformation stretches or shrinks the time series by interpolation or decimation. It uses up-sampling, convolution, and then downsizing. In doing so, it uses a Hamming window with cut-off frequency and length determined from a greatest common denominator of the source and target time series lengths.

These known approaches work well for the middle part of the curve, but show significant boundary effects. Specifically, the shape of the target curve does not match the original curve at the beginning and end. Typically the leading three to five periods and the trailing three to five periods will not match the original curve's shape. However, the leading and trailing periods can affect the total buy of the merchandise. If the sales at beginning and ending of the lifecycle curve are not correct, the total projected sales, represented by the area under the curve, is inaccurate. This negative effect is particularly problematic for short lived merchandise, where the beginning and end of the lifecycle can actually make up more than half of the total curve.

Further, the shape of the curve towards the end of the lifecycle directly influences the need for price markdowns. The shape of the curve drives the forecast of the item. If the values are higher than they should be, the forecast for the item is higher. The result is that the retailer risks having unsold items by not aggressively marking down prices. If the shape is lower than expected, the forecast is lower, and the retailer tries to increase demand by marking down the prices. The result is margin erosion due to unnecessary markdowns.

In contrast, embodiments modify the retail sales curve with minimal boundary effects, therefore providing a more accurate sales forecast.

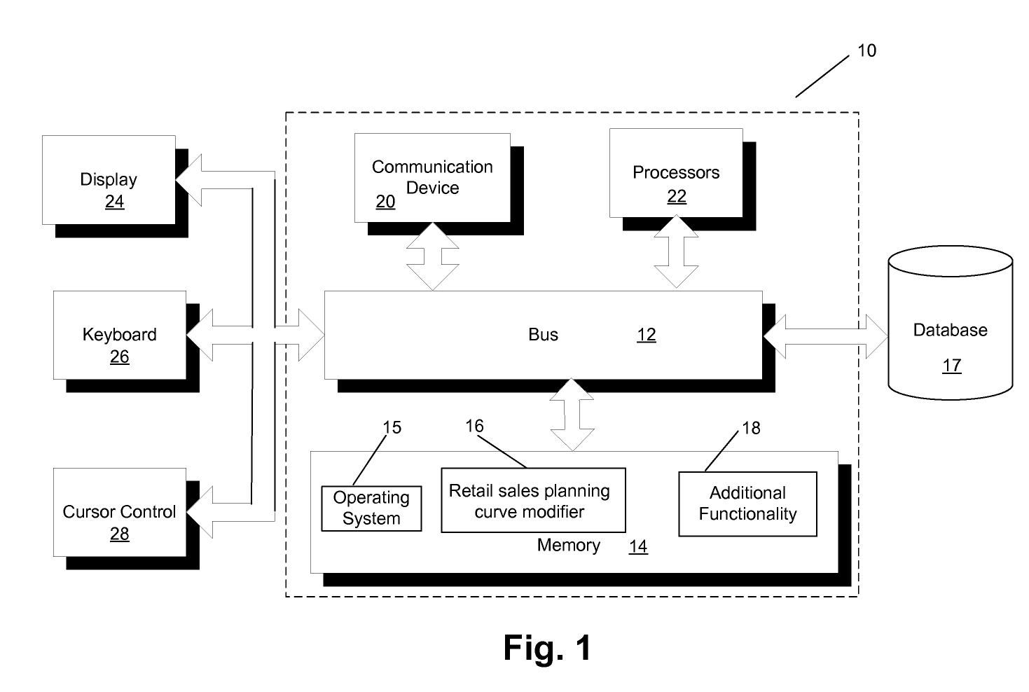

FIG. 1 is a block diagram of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. For example, for functionality of a user client, system 10 may be a smartphone that includes a processor, memory and a display, but may not include one or more of the other components shown in FIG. 1.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include a retail sales planning curve modifier module 16 for modifying a retail sales planning curve, and all other functionality disclosed herein. System 10 can be part of a larger system. Therefore, system 10 can include one or more additional functional modules 18 to include the additional functionality, such as the “Retail Demand Forecasting” module for the “Retail Predictive Application Server” (“RPAS”) from Oracle Corp. A database 17 is coupled to bus 12 to provide centralized storage for modules 16 and 18.

One embodiment provides a retail sales planning curve modifier function that uses the shape of a time series of a retail sales curve to produce another time series of a different length, but with the same or a similar shape, normalized to a specific total. The function, referred to as “resizeProfile” in one embodiment, has the following inputs:

resizeProfile(expression, start, fromlength, tolength, dststart: <dststart>, total: <total>).

The following are the inputs to the function in one embodiment:
1. expression: a measure or expression, whose time series is to be used in the calculations.
2. start: denotes the index number of the calendar dimension of expression. Embodiments process data points from this index number going forward.
3. fromlength: together with start, this input establishes which portion of the curve should be processed. fromlength determines the length of the original curve.
4. tolength: determines the length of the output curve.
5. dststart: this is a named value pair denoting an optional input, which determines the index of the starting point of the output curve. If not specified, it defaults to zero.
6. total: this is a named value pair denoting an optional input whose numeric value is used to normalize the resized curve. If total is not specified, normalize to the sum of values of input curve.

One embodiment initially validates the inputs as follows:
1. fromlength and tolength should be integer measures. They can be scalars, and are not required to have a calendar dimension. If the values are numeric but non-integer, only the integer portion should be used.
2. Need to check that fromlength and tolength are greater than zero.
3. Need to check that fromlength and tolength do not exceed the length of the calendar.
4. start and dststart should be integer measures. They can be scalars, and are not required to have a calendar dimension. They can be date measures as well, and then they need to be converted to an index measure internally.
5. Need to check that start and dststart are within the calendar.
6. Need to check if (start+fromlength), as well as (dststart+tolength) or (start+tolength) are not exceeding the length of the calendar (or whatever dimension the function works on).
7. total should be a real measure. It can be a scalar, and is not required to have a calendar dimension.
8. The total measure should be greater than zero. If the value is zero or less, write to a log that the value was invalid, and skip to the next time series.
9. The only inputs that are required to have a calendar dimension are the output and the expression input.
10. Check to see if the output measure is cleared before calculations start. Keep the same for the new function.

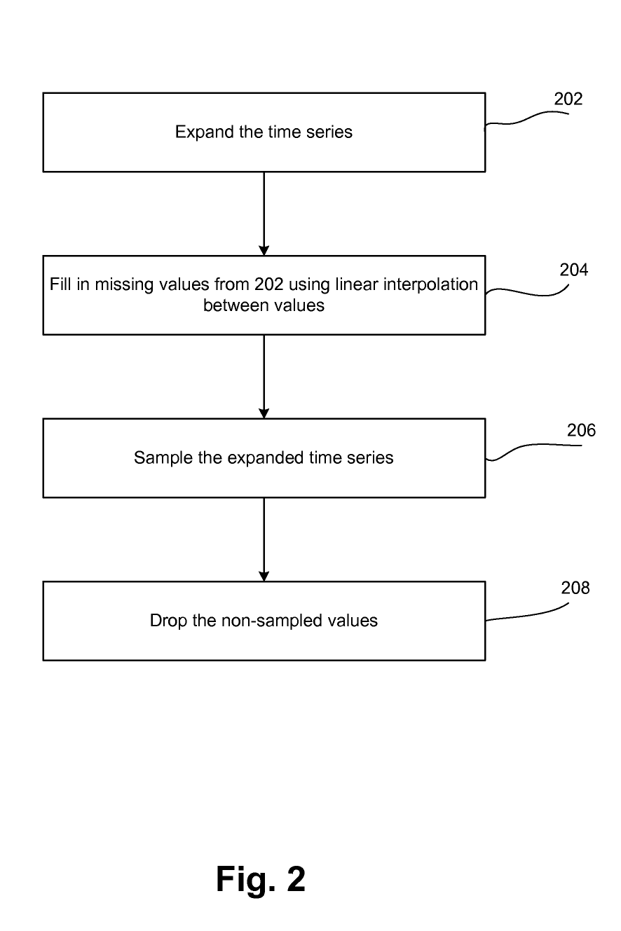

FIG. 2 is a flow diagram of the functionality of retail sales planning curve modifier module 16 of FIG. 1 when modifying a retail sales planning curve in accordance with one embodiment. In one embodiment, the functionality of the flow diagram of FIG. 2 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

The functionality of FIG. 2 receives as input a time series curve of length “M” periods (fromlength) and provides as output a transformed time series curve of length “N” (tolength) periods. If M=N, the functionality of FIG. 2 is not needed as only a simple copy of the curve is needed. If M>N, the curve will shrink when modified. If M<N, the curve will expand when modified. In the below discussion in conjunction of FIG. 2, an example is given for the case of M<N. However the same functionality is used for the case of M>N.

At 202, the time series is expanded. The expansion is determined by the lengths of the original and target shapes. The length is given by the number of time periods—for instance weeks—where the shape is different from zero. In one embodiment, the time series is expanded to a length of a (M−1)×(N−1)+1 time series. M−1 values are then entered in the expanded time series every N−1 positions. The “Mth” value is then entered at position (M−1)×(N−1)+1. The other positions remain unfilled or temporarily are assigned a 0.

For example, assume the curve has data for three periods (2, 4, 3) and the length is to be expanded from three periods to five periods. In this case M=3 and N=5. At 202 the series is expanded to a length of (M−1)×(N−1)+1, and M−1 values of the input curve are entered every N−1 positions, and 0 in the remaining positions, resulting in: (2, 0, 0, 0, 4, 0, 0, 0). The “Mth” value is then entered at position (M−1)×(N−1)+1, resulting in: (2, 0, 0, 0, 4, 0, 0, 0, 3).

At 204, the time series data is linearly interpolated to fill in the remaining positions instead of 0. The result in the example is: (2, 2.5, 3, 3.5, 4, 3.75, 3.5, 3.25, 3), where the interpolated values are in bold.

At 206, the expanded series is sampled every M−1 values. In the example M=3, so every 2 (=M−1) values should be sampled (i.e., a subset of the values is selected). The sampled values are in bold as follows: (2, 2.5, 3, 3.5, 4, 3.75, 3.5, 3.25, 3).

At 208, the non-sampled values are dropped to produce the resized curve. In the example, the resized curve is (2, 3, 4, 3.5, 3). It is noted that the first and last data points are the same in both the input and output curves.

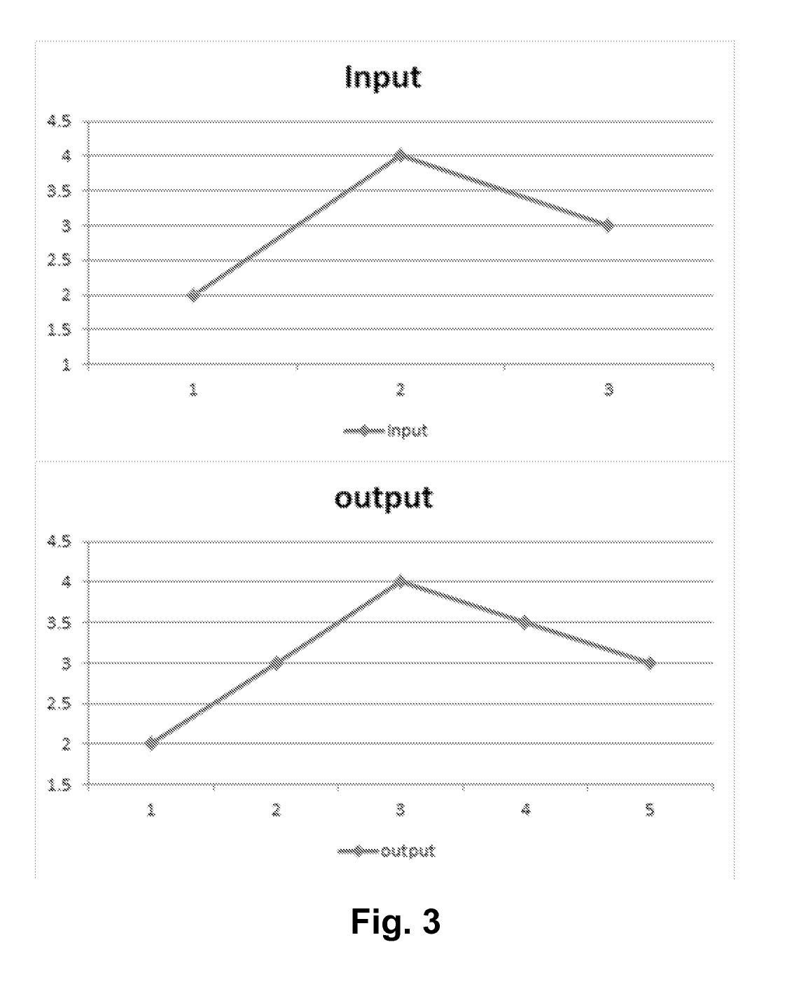

FIG. 3 illustrates the input curve and output expanded curve for the preceding example in accordance with one embodiment.

An example of when the original curve is shrunk (i.e., M>N) is as follows: assume the curve (2, 5, 4, 2, 3) is to be shrunk from length five to length four. In this case M=5 and N=4.

As in 202, the series is first expanded to (M−1)×(N−1)+1 and M−1 values of the input curve are entered every N−1 positions. The result is: (2, 0, 0, 5, 0, 0, 4, 0, 0, 2, 0, 0). At position (M−1)×(N−1)+1 the “Mth” value is entered: (2, 0, 0, 5, 0, 0, 4, 0, 0, 2, 0, 0, 3). The total length of the expanded series is (5−1)×(4−1)+1=13, exactly as in the preceding example.

As in 204, the “holes” between the M input values are filled in by linearly interpolating the data, resulting in: (2, 3, 4, 5, 4.67, 4.33, 4, 3.33, 2.67, 2, 2.33, 2.67, 3), with the interpolated values in bold.

As in 206, the expanded series is sampled every M−1 values. In this example, M=5, so the sampling is every 4 (=M−1) values, resulting in: (2, 3, 4, 5, 4.67, 4.33, 4, 3.33, 2.67, 2, 2.33, 2.67, 3), where the bolded values are the sampled values.

As in 208, the sampled values are collected from the expanded series to produce the resized curve, while dropping all values from in between. The resulting resized curve is: (2, 4.67, 2.67, 3).

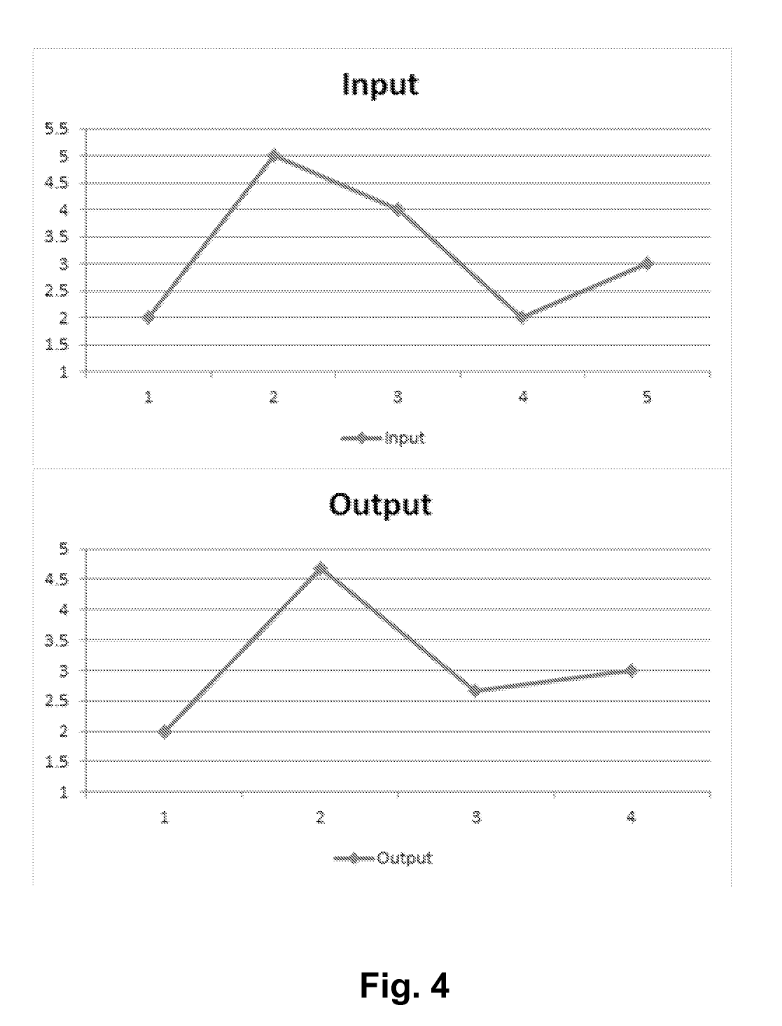

FIG. 4 illustrates the input curve and output shrunken curve for the preceding example in accordance with one embodiment.

In addition to the functionality of FIG. 2, in one embodiment, after the resized curve is created, the resized curve can be scaled up or down or normalized, so that the sum of the output equals total provided as an input, or equals the sum of the values of the input curve. For example, for the input curve of FIG. 3, the sum of values would be 9.

The following pseudo-code can be used to perform the normalization in accordance with one embodiment:

### Denote:

sum_original: sum of values of the original curve along the innermost dimension
sum_resized: sum of values of resized curve along the innermost dimension, BEFORE rescaling
sum_output: sum of values of output curve along the innermost dimension
factor: real coefficient
resized: resized curve
output: output curve
   Calculate the following:
sum_original
sum_resized
factor=sum_original/sum_resized
   If total is not specified, force:
sum_output=sum_original

### Finally:

output=factor*resized
   If total is specified, force:
sum_output=total

### Finally:

output=factor*(total/sum_original)*resized

As a numerical example of a scaling/normalization determination, assume the above example for M<N when total is NOT specified. In that example, the input went from

M=3, input=(2, 4, 3)
to
N=5, resized=(2, 3, 4, 3.5, 3).

### Therefore:

sum_original=2+4+3=9
sum_resized=2+3+4+3.5+3=15.5
factor=sum_original/sum_resized=9/15.75=0.5806
output=factor*resized=0.5806*(2, 3, 4, 3.5, 3)=(1.1612, 1.7418, 2.3224, 2.0321, 1.7418).

Using the above example of M>N to illustrate the scaling determination when total=52, the input went from

M=5, input=(2, 5, 4, 2, 3)
to
N=4, resized=(2, 4.67, 2.67, 3).

### Therefore:

total=52
sum_original=16
sum_resized=12.3333334
factor=1.2973
output=1.297*52/16*(2, 4.67, 2.67, 3)=(8.434, 19.675, 11.243, 12.648).

One embodiment further performs a shifting functionality to shift the output curve along the calendar to the index value specified in dststart. If dststart is omitted, the output curve will be shifted to the first position of the calendar (e.g., the first week) in one embodiment. Using the above preceding example:

If dststart is omitted, the output is: (8.434, 19.675, 11.243, 12.648, 0, 0, . . . , 0). Note how the curve starts at the beginning of the calendar.

If dststart=5, the output is: (0, 0, 0, 0, 0, 8.434, 19. 675, 11.243, 12.648, 0, 0, . . . , 0). Note how the first 5 periods are zero, and the curve starts from the 6^{th} position.

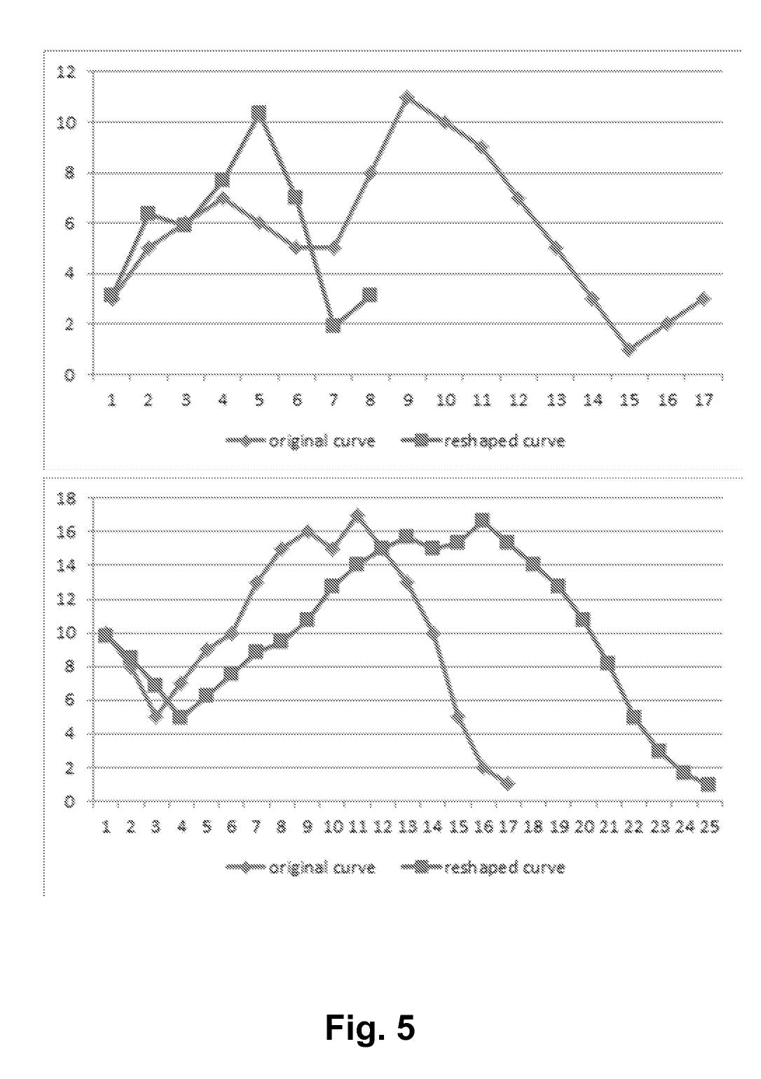

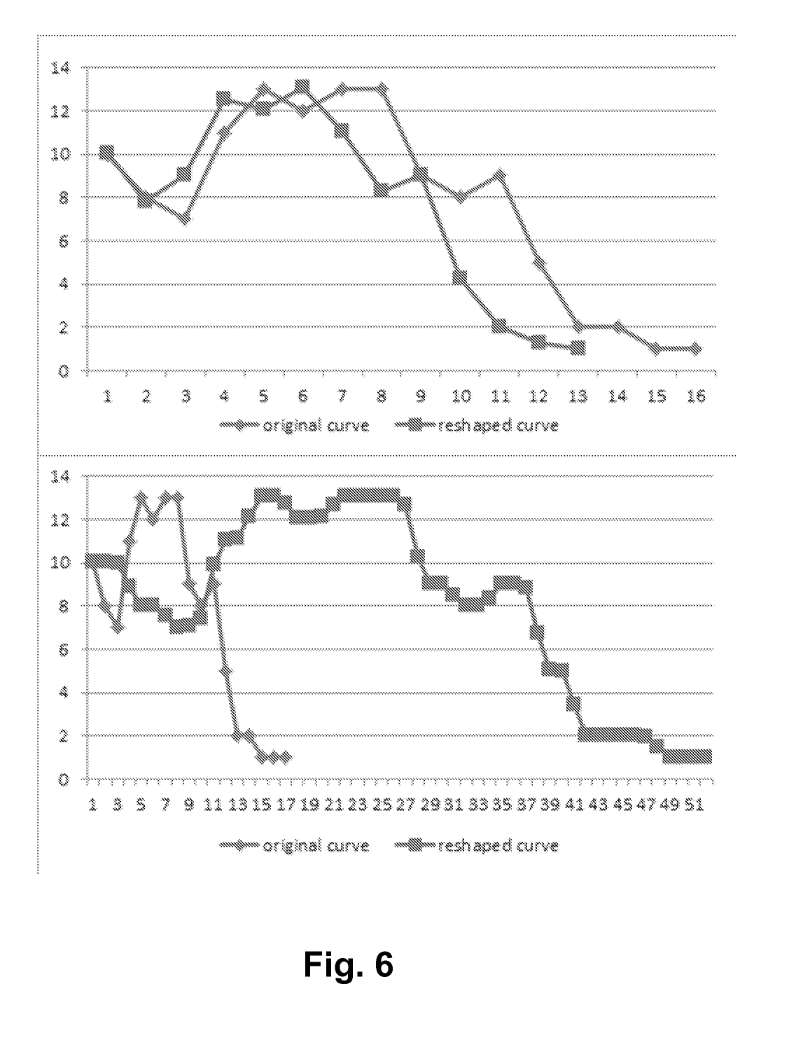

FIGS. 5 and 6 illustrate additional examples of input and output curves in accordance with embodiments of the invention.

Additional embodiments perform variations of the functionality of FIG. 2 in order to speed up calculations, which is especially useful for curves with a large number of periods.

In one embodiment, if (M−1)=k*(N−1) (i.e., shrinking), then from the original series, keep every k points, where k is an integer.

As a specific example, assume the original series is:
(2, 100, 100, 4, 100, 100, 3)

### M=7; M−1=6

### N=3; N−1=2

k=3
Therefore, keep every third point:
(2, 100, 100, 4, 100, 100, 3)→(2, 4, 3)
By doing this instead of the full expansion, the expanded series is going from a (M−1)*(N−1)+1 size to a size of M. In this example:
Full expansion size=13.
Modified approach size=7.

In another embodiment, if (M−1)*k=(N−1) (expanding),

enter (M−1) values every k positions,
interpolate the 0 values,

### OR

expand the series as follows:
(First value in original series, 0 (k−1) times, second value in original series, 0 (k−1) times, third value in original series, 0 (k−1), etc.);
interpolate to get values.
   As a specific example, assume the original series is:
   (2, 4, 3)

### M=3, M−1=2

### N=7, N−1=6

k=3
Expanded series is:
(2, 0, 0, 4, 0, 0, 3)
Interpolate to get missing values:
(2, 2.67, 3.33, 4, 3.67, 3.33, 3)→(2, 2.67, 3.33, 4, 3.67, 3.33, 3).
By doing this instead of the full expansion, the expanded series goes from a (M−1)*(N−1)+1 size to a size of N.
In this example:
Full expansion size=13.
Modified approach size=7.

In another embodiment, if (M−1) and (N−1) have common factors: Divide both (M−1) and (N−1) by the largest common factor, “k”. Thus (M′−1) and (N′−1) are relative prime

(M′−1)=k*(M−1)
(N′−1)=k*(N−1)
Expand series to a (M′−1)×(N′−1)+1 series:
enter a value from the original series every (N′−1) points
interpolate to get missing values
sample every (M′−1) values.
   Original series:
   (2, 3, 2, 5, 3)

### M=5, M−1=4

### N=7, N−1=6

k=3,

### (M′−1)=2

### (N′−1)=3

Expand series:
(2, 0, 0, 3, 0, 0, 2, 0, 0, 5, 0, 0, 3)
Interpolate to get values
(2, 2.33, 2.66, 3, 2.67, 2.33, 2, 3, 4, 5, 4.33, 3.67, 3)
Sample every M′−1=2 points
(2, 2.33, 2.66, 3, 2.67, 2.33, 2, 3, 4, 5, 4.33, 3.67, 3)->(2, 2.66, 2.67, 2, 4, 4.33, 3) By doing this instead of the full expansion, the expanded series goes from a (M−1)*(N−1)+1 size to a size of (M′−1)*(N′−1)+1. In this example:
Full expansion size=25
Modified approach size=13

As disclosed, embodiments resize or modify a sales planning curve by expanding, linearly interpolating, and sampling the time series. In one embodiment, the curve is expanded by the multiplication of the (original length−1) times the (target length−1) plus 1 and then downsized. The result is a modified planning curve with minimal boundary effects.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer-readable medium having instructions stored thereon that, when executed by a processor, cause the processor to modify an input sales planning curve comprised of a time series, the modifying comprising:
expanding the time series from an initial length time series to an expanded length time series, the expanded length time series comprising one or more missing values;
filling in the missing values using linear interpolation;
sampling the expanded time series by selecting a subset of the expanded length time series values; and
dropping the values not selected during the sampling to generate an output sales planning curve.

2. The computer-readable medium of claim 1, wherein the input sales planning curve comprises M periods, and the output sales planning curve comprises N periods, the expanded length time series comprising a length of (M−1)×(N−1)+1.

3. The computer-readable medium of claim 2, wherein the expanding comprises entering M−1 values in the expanded length time series every N−1 positions.

4. The computer-readable medium of claim 3, wherein the expanding comprises entering a value of M at a position (M−1)×(N−1)+1.

5. The computer-readable medium of claim 2, wherein selecting the subset of the expanded length time series values comprises selecting every M−1 values.

6. The computer-readable medium of claim 1, further comprising normalizing the output sales planning curve, wherein a sum of values of the output sales planning curve equals either a sum of values of the input sales planning curve, or a user provided value.

7. The computer-readable medium of claim 1, further comprising shifting the output sales planning curve along a calendar to an index value or a first position of the calendar.

8. A method of modifying an input sales planning curve comprised of a time series, the method comprising:
expanding the time series from an initial length time series to an expanded length time series, the expanded length time series comprising one or more missing values;
filling in the missing values using linear interpolation;
sampling the expanded time series by selecting a subset of the expanded length time series values; and
dropping the values not selected during the sampling to generate an output sales planning curve.

9. The method of claim 8, wherein the input sales planning curve comprises M periods, and the output sales planning curve comprises N periods, the expanded length time series comprising a length of (M−1)×(N−1)+1.

10. The method of claim 9, wherein the expanding comprises entering M−1 values in the expanded length time series every N−1 positions.

11. The method of claim 10, wherein the expanding comprises entering a value of M at a position (M−1)×(N−1)+1.

12. The method of claim 9, wherein selecting the subset of the expanded length time series values comprises selecting every M−1 values.

13. The method of claim 8, further comprising normalizing the output sales planning curve, wherein a sum of values of the output sales planning curve equals either a sum of values of the input sales planning curve, or a user provided value.

14. The method of claim 8, further comprising shifting the output sales planning curve along a calendar to an index value or a first position of the calendar.

15. A retail sales planning system comprising:
a processor;
a memory device coupled to the processor that stores a retail sales planning curve modifier module;
the module, when executed by the processor, in response to receiving an input sales planning curve for a first retail item comprised of a time series, is configured to:
expand the time series from an initial length time series to an expanded length time series, the expanded length time series comprising one or more missing values;
fill in the missing values using linear interpolation;
sample the expanded time series by selecting a subset of the expanded length time series values; and
drop the values not selected during the sampling to generate an output sales planning curve for a second retail item different from the first retail item.

16. The system of claim 15, wherein the input sales planning curve comprises M periods, and the output sales planning curve comprises N periods, the expanded length time series comprising a length of (M−1)×(N−1)+1.

17. The system of claim 16, wherein the expanding comprises entering M−1 values in the expanded length time series every N−1 positions and entering a value of M at a position (M−1)×(N−1)+1.

18. The system of claim 16, wherein selecting the subset of the expanded length time series values comprises selecting every M−1 values.

19. The computer-readable medium of claim 1, wherein the input sales planning curve comprises M periods, and the output sales planning curve comprises N periods, the expanded length time series comprising, when (M−1)=k*(N−1), keeping every k points of the input sales planning curve.

20. The computer-readable medium of claim 1, wherein the input sales planning curve comprises M periods, and the output sales planning curve comprises N periods, the expanded length time series comprising, when (M−1)*k=(N−1), alternating the time series values with 0 (k−1) times.
